(19) United States
(12) Patent Application Publication
(10) Pub. No.: US 2020/0218055 A1
(43) Pub. Date: Jul. 9, 2020

(54) Long-wave infrared optical system for observing devices using the principle of the Cassegrain telescope

(71) Applicant: VIETTEL GROUP, Ha Noi City (VN)

(72) Inventors: TIEN HAI TRAN, Ha Noi City (VN); QUANG TRUNG TRINH, Ha Noi City (VN); DUY NHAT TRAN, Vinh City (VN); THANH LUONG NGUYEN, Ba Don town, Quang Binh province (VN)

(73) Assignee: VIETTEL GROUP, Ha Noi City (VN)

(21) Appl. No.: 16/732,809

(22) Filed: Jan. 2, 2020

(30) Foreign Application Priority Data
Jan. 3, 2019 (VN) 1-2019-00038

(51) Int. Cl. G02B 23/02; G02B 5/10; G02B 13/00; G02B 13/14; G02B 13/18

(52) U.S. Cl. CPC G02B 23/02; G02B 5/10; G02B 13/18; G02B 13/14; G02B 13/0095

(57) ABSTRACT

The invention proposed the design of an optical system using the principle of Cassegrain telescopes for a long wave radiation range, which consists of two main components: the first component comprising the two reflective mirrors, in which surface distortion of mirror 1 is parabolic, surface distortion of mangin mirror 2 is aspheric; the second component is a relay consisting of three lenses: lens 1, lens 2, and lens 3 arranged after the medial image plane correspondingly; it plays an important role in fixing the pupil's position to match the position of the cold shield of the sensor and eliminating absolutely the aberration to ensure receiving good quality image at the sensor plane.

### TECHNICAL FIELD

The invention relates to the field of optoelectronics and infrared engineering. Specifically, the invention proposes a long-wave infrared optical system (the wavelength is 8-12 μm) using the principle of the Cassegrain telescope and mangin mirror in design process. This optical system is compatible with modern infrared sensors having cold shield and an aperture F #2.

### BACKGROUND OF THE INVENTION

In the published patent documents, some works have the content concerning catadioptric design for infrared radiation of the long wave range. Some shortcomings and limitations of the published inventions remain as follows:

United States Published Patent Application No. 20030206338 A1 published on Jun. 11, 2003 describes a optical system using a Cassegrain mirror that creates an image simultaneously for long waves and millimeter wave radiation. The advantage of the invention is that the optical system operates in a wide range of spectra, being flexible in device deployment. However, the disadvantage of the invention is that the quality of the system causes non-coaxial aberration, difficult to control tolerances when assembling. Also the element arrangement of the invention does not help optimize the size of the device. It is interesting that the invention does not mention the technical characteristics of the system nor the image quality obtained at the sensor plane.

To overcome the above limitations, the authors of the Viettel Aerospace Institute propose the design of an optical system using the principle of Cassegrain telescopes for a long wave radiation range with compact size giving high-quality images that are compatible with cooler detectors currently on the market.

### BRIEF SUMMARY OF THE INVENTION

The purpose of the invention is to propose the design of an optical system using the principle of Cassegrain telescopes for a long wave that works well with a modern cooler detector with a resolution less than 15 μm pixel. Accordingly, the optical system has a large aperture of F #2 for high quality images at the sensor plane.

To achieve the above goal, the catadioptric system consists of two main components: the first one consists of mirrors 1 (1) and mangin mirrors 2 (2) made of Gallium Arsenide (GaAs), reflects signal from infinity and creates intermediate image before the relay system; the second is the relay system consisting of three lenses: 1 (3) lens, 2 (4) lens, 3 lens (5). Lens 1 (3) and lens 3 (5) are made of Germanium (Ge), lens 2 (4) is made of Chalcogenide (IRG 205), which helps remove aberration for good quality images at sensor plane. In addition, the relay plays an important role in fixing the pupil's position to match the position of the cold shield of the sensor.

The relay system is arranged in a space obscuring the center of the light path between the two reflecting elements of the first cluster to ensure the compact optical system.

### BRIEF DESCRIPTION OF THE DRAWINGS

FIG. 1: Structure and symbol of elements of optical system stated in the invention;

FIG. 2: Graph of MTF (Module Transfer Function);

FIG. 3: Spot size at three viewing fields;

FIG. 4: Field curvature graph and image distortion graph at sensor plane;

FIG. 5: Diagram of the rays of light when passing through the optical system.

### DETAILED DESCRIPTION OF THE INVENTION

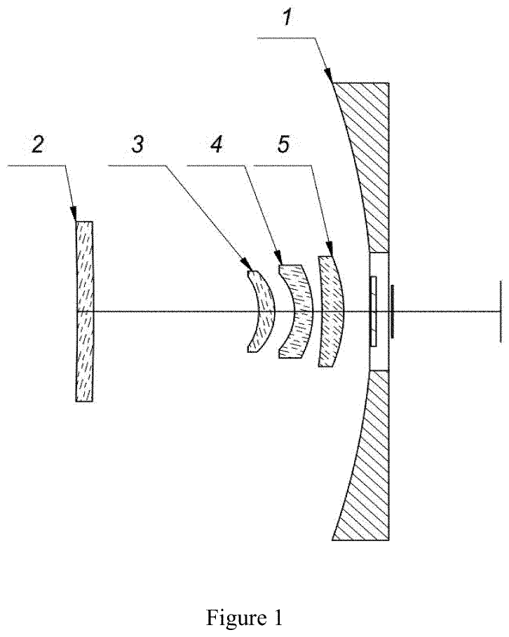

In FIG. 1: The figure illustrates the main structures of the optical system proposed in this invention. The optical system consists of two main components:

The first one consists of mirrors 1 (1) and mangin mirror 2 (2) arranged so that the two reflective surfaces are facing each other, in which the mirror 1 (1) is positioned farther from the external environment than the mangin mirror 2 (2). Mirror 1 (1) have smooth surfaces that meet reflection coefficient greater than or equal to 99%, the surface of mirror 1 (1) is parabolic. The details of the first component's structure are as follows:

Mirror surface 1 (1) satisfies:

$$Z ( y ) = \frac{{y}^{2}}{R \cdot ⌈ 1 + \sqrt{1 - ( 1 + K ) \cdot \frac{{y}^{2}}{{R}^{2}}} ⌉} \qquad ( 1 )$$

Where: [symbol] is Conic coefficient;

[symbol]

is the radius of top of the mirror surface.

Mangin mirror (2) has a meniscus shape made of Gallium Arsenide

(GaAs), The mangin mirror contains spherical has a radius [symbol] and [symbol] . Reflective coated surface is a surface with a radius [symbol] .

The first component receives the signal in infrared radiation form from infinity, after two times reflections creates the real image at the intermediate image plane with the shading rate of the mangin mirror 2 (2) to mirror 1 (1) being:

$$\frac{{D}_{2}}{{D}_{1}} = \frac{33 , 4}{89 , 8} = 0 , 37 \qquad ( 2 )$$

where [symbol] and [symbol] is a bright shading ratio of mangin mirror (2) with mirror (1).

With the ratio above, the signal level remaining after the loss is:

$$τ = 1 - {( \frac{D 2}{D 1} )}^{2} = 1 - 0 , 3 {7}^{2} = 0 , 8631 = 86 , 31 \% \qquad ( 3 )$$

With linear dependence of position, the size of the medial image plane relating to the radius and distance between mirror 1 (1) and mirror 2 (2), the radius of the two reflective mirrors and the distance between two mirrors are designed to ensure light rays convergence at the intermediate image plane. Therefore, it will ensure receiving the real image in the intermediate image plane.
The second component is a relay consisting of three lenses: lens 1 (3), lens 2 (4), lens 3 (5) are arranged after the medial image plane correspondingly. To adjust the pupil matching the position and size with the cold shield, the optical system is designed to optimize the position of the relay to ensure meeting target of the sensor, while also to eliminate the aberration to ensure receiving good quality image.
   In particular:

+ Lens 1 (3): has a meniscus shape made of Germanium (Ge), covered with anti-reflective coating and transmission greater than or equal to 99%. The lens contains one spherical surface and one aspheric surface, in which the concave spherical surface has a radius [symbol] and the aspheric has a surface satisfying:

$$z ( y ) = \frac{{y}^{2}}{R \cdot ⌈ 1 + \sqrt{1 - \frac{{y}^{2}}{{R}^{2}}} ⌉} + {A}_{4} \cdot {y}^{4} + {A}_{6} \cdot {y}^{6} + {A}_{8} \cdot {y}^{8} + {A}_{10} \cdot {y}^{10} + {A}_{12} \cdot {y}^{12} \qquad ( 4 )$$

Where: [symbol] is the radius of top of the aspheric surface;

[symbol] [symbol] [symbol] [symbol] [symbol] are surficial coefficients.

+ Lens 2 (4): has a meniscus shape made of Chalcogenide (IRG 205), covered with anti-reflective coating and transmission greater than or equal to 99%. The lens contains one spherical surface and one aspheric surface, in which the concave spherical surface has a radius [symbol] and the aspheric has a surface satisfying:

$$z ( y ) = \frac{{y}^{2}}{R \cdot ⌈ 1 + \sqrt{1 - \frac{{y}^{2}}{{R}^{2}}} ⌉} + {A}_{4} \cdot {y}^{4} + {A}_{6} \cdot {y}^{6} + {A}_{8} \cdot {y}^{8} + {A}_{10} \cdot {y}^{10} + {A}_{12} \cdot {y}^{12} \qquad ( 5 )$$

Where: [symbol] is the radius of top of the aspheric surface;

[symbol] [symbol] [symbol] [symbol] [symbol] are surficial coefficients.

+ Lens 3 (5): has a meniscus shape made of Germanium (Ge), covered with anti-reflective coating and transmission greater than or equal to 99%. The lens contains two spherical surfaces have radius [symbol] and

[symbol]

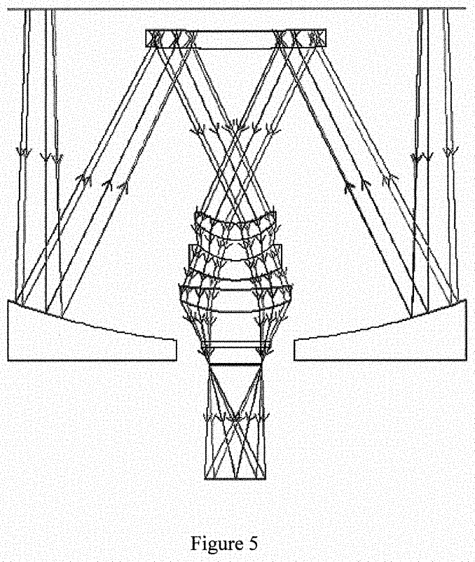

In FIG. 5, the light ray path for the optical system after designing is as follows: Mirror 1 (1) is the surface receiving the signal from the infinite infrared radiation at first in the optical system. That signal will then reflect to mangin mirror 2 (2), which will continue to be reflected to create a real image in the intermediate image plane. The signal after creating real image is refracted one by one through lens 1 (3), lens 2 (4), lens 3 (5) then through the cold shield and converges to create image at the sensor plane.

According to the proposed design, high quality image can be obtained at the sensor plane. The characteristics of the system are optimally calculated to control the position and size of intermediate images before the relay system creates image at the sensor plane. Due to the structure of the cooler detector consisting of cold shield, it is also designed and optimized for the pupil to match the position and size with this window.

By using two reflectors and controlling the position of intermediate image plane, the optical system with the most optimal performance when having a total length of 81 mm, operates in the spectral band 8-12 μm; the focal length is 150 mm; 1:1.93 aperture and viewing field 2.9×3.6 degrees. Specifically, the detailed structure parameters of the device are shown in the following table:

TABLE 1
Parameters and detailed structures of the optical system

| Radius of | | | Diameter of |
|---|---|---|---|
| curvature | Axial thickness | Material | light beam |
| −146.89 | −51.175 | Aluminum (Al) | 89.8 |
| −567.5 | −3 | Gallium Arsenide (GaAs) | 33.4 |
| −499.702 | 30.344 | | 32.7 |
| −15.453⁽*⁾ | 2.89 | Germanium (Ge) | 14.50 |
| −11.96 | 3.627 | | 16.47 |
| −11.96 | 3.43 | Chalcogenide (IRG 205) | 15.376 |
| −20.930⁽*⁾ | 1.65 | | 18.88 |
| −99.248 | 4 | Germanium (Ge) | 21.532 |
| −30.69 | 4.957 | | 22.414 |

Note:
⁽*⁾are aspheric surfaces.

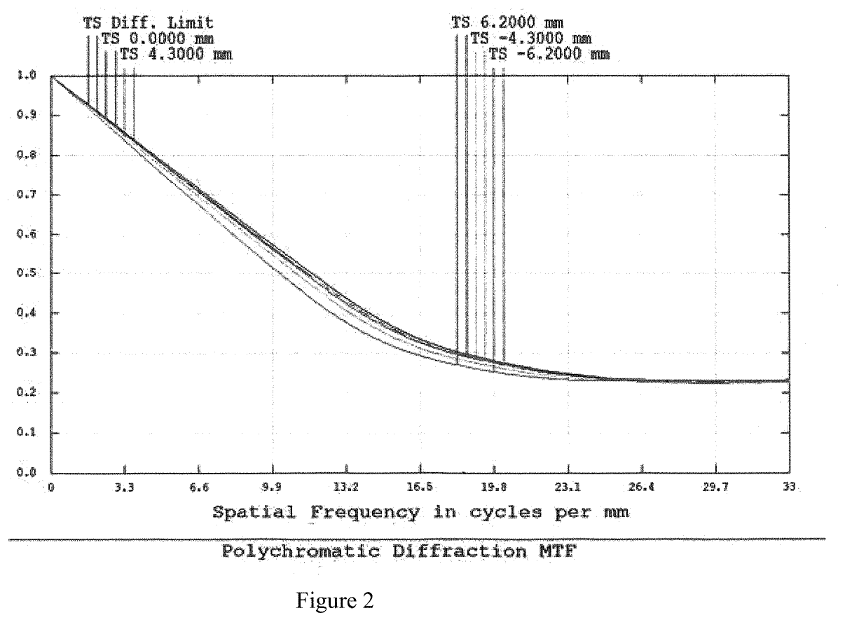

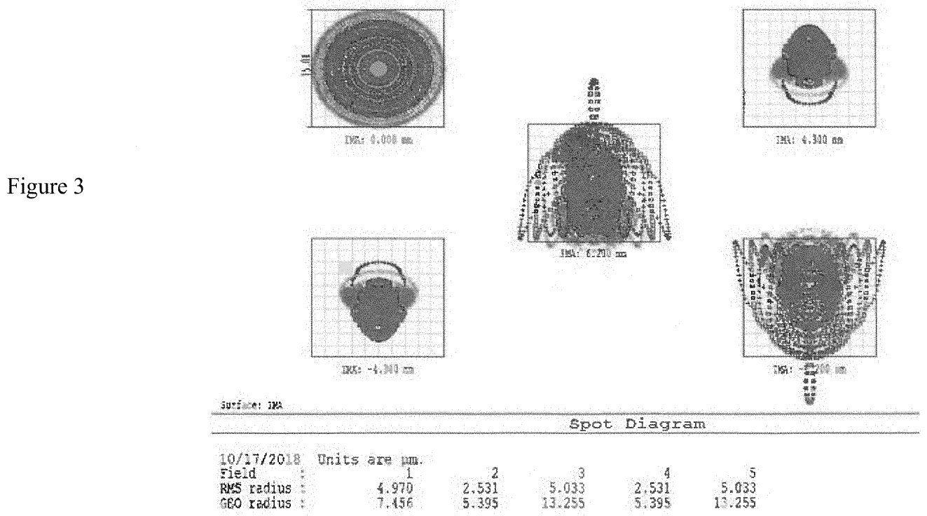

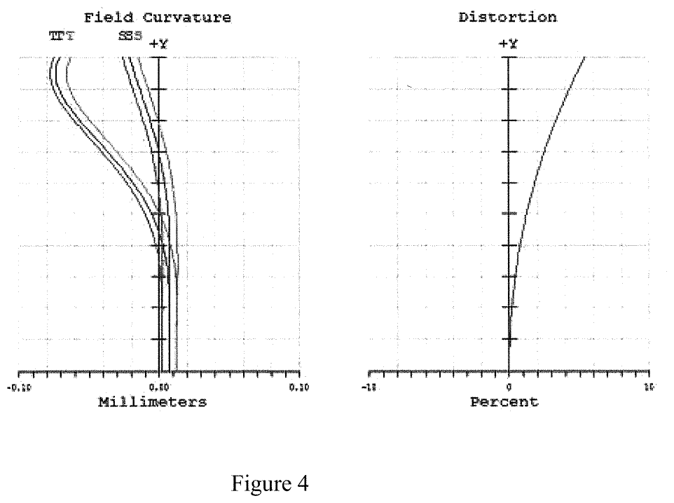

Parameters such as radius of curvature, Conic coefficient and aspheric surficial coefficient of optical system are optimized to achieve the best quality image at the sensor plane. Graphs showing quality of optical system are described in FIG. 2, FIG. 3, and FIG. 4, where:
In FIG. 2: Module Transfer Function represents image quality at three fields 0; 0.7 and 1 approximately diffraction limit, which was shown by the fact that the lines are nearly overlapped. Also at the limited frequency Nyquist (ν_{N}=30 mm⁻¹) transfer function is approximately 0.25;
In FIG. 3: Representation of Poisson spot size is over 1 pixel of different viewing fields. It is easy to see those light streaks have diffraction radius (RMS) less than 15 μm;
In FIG. 4: Representing the field curvature graph of three wavelengths at the Tangential and Sagittal planes. It is easy to determine that all graphs have the variation of field curvature less than 0.1 mm. In addition, the image distortion is less than 5%.

Accordingly, the proposed optical system ensures that the lens has a compact size, high quality image, and is capable of being used with cooling sensors having a cold shield.

1. An optical system using the principle of Cassegrain telescopes for long-wave thermal imaging equipment comprising two components:
the first component comprises of two reflective mirrors, made of aluminum and Gallium Arsenide (GaAs): mirror 1 and mangin mirror 2, where a surface of mirror 1 is parabolic, a surface of mangin mirror 2 is spheric; mirror 1 and mangin mirror 2 are arranged so that a reflective surface of mirror 1 and a reflective surface of mangin mirror 2 are facing each other;
the second component comprises a relay consisting of three lenses: lens 1, lens 2, and lens 3 arranged after a medial image plane correspondingly; the second component plays an important role in fixing a pupil's position to match a position of a cold shield of a sensor and eliminating absolutely aberration to ensure receiving good quality image at a plane of the sensor in which:
+ Lens 1 has a meniscus shape made of a Germanium (Ge), covered with anti-reflective coating and transmission greater than or equal to 99%, lens 1 contains one spherical surface and one aspheric surface;
+ Lens 2 has a meniscus shape made of a Chalcogenide (IRG 205), covered with anti-reflective coating and transmission greater than or equal to 99%; lens 2 contains one spherical surface and one aspheric surface.
+ Lens 3 has a meniscus shape made of Germanium (Ge), covered with anti-reflective coating and transmission greater than or equal to 99%. The lens contains two spherical surfaces.

2. The system according to claim 1 has parameters and detailed structures of the optical system

| Radius of | | | Diameter of |
|---|---|---|---|
| curvature | Axial thickness | Material | light beam |
| −146.89 | −51.175 | Aluminum (Al) | 89.8 |
| −567.5 | −3 | Gallium Arsenide (GaAs) | 33.4 |
| −499.702 | 30.344 | | 32.7 |
| −15.453⁽*⁾ | 2.89 | Germanium (Ge) | 14.50 |
| −11.96 | 3.627 | | 16.47 |
| −11.96 | 3.43 | Chalcogenide (IRG 205) | 15.376 |
| −20.930⁽*⁾ | 1.65 | | 18.88 |
| −99.248 | 4 | Germanium (Ge) | 21.532 |
| −30.69 | 4.957 | | 22.414 |

3. The system according to claim 1 optical system with the most optimal performance having a total length of 81 mm, operates in the spectral band 8-12 μm; the focal length is 150 mm; 1:1.93 aperture and viewing field 2.9×3.6 degrees.

4. The system according to claim 2 optical system with the most optimal performance having a total length of 81 mm, operates in the spectral band 8-12 um; the focal length is 150 mm; 1:1.93 aperture and viewing field 2.9×3.6 degrees.
